(19) United States
(12) Patent Application Publication
(10) Pub. No.: US 2024/0187937 A1
(43) Pub. Date: Jun. 6, 2024

(54) CONCURRENT ACCESS POINT PRE-AUTHENTICATION

(71) Applicant: QUALCOMM Incorporated, San Diego, CA (US)

(72) Inventors: Sai Vamshi Ragiphani, Hyderabad (IN); Venkatesh Chitturi, Hyderabad (IN); Sunil Undekari, Hyderabad (IN)

(21) Appl. No.: 18/062,426

(22) Filed: Dec. 6, 2022

(51) Int. Cl. H04W 36/00; H04W 12/041; H04W 12/062

(52) U.S. Cl. CPC H04W 36/0038; H04W 12/041; H04W 12/062; H04W 36/00835

(57) ABSTRACT

Techniques related to Fast Basic Service Set (BSS) Transition (FT) in IEEE 802.11 Wi-Fi are disclosed. Some aspects of the disclosure relate to devices and methods for pre-authenticating a plurality of access points (APs) using a modified FT procedure. An AP may obtain an FT action request frame from a station (STA), the FT action request frame including a list of a plurality of candidate APs. The AP may communicate (e.g., over a distribution system (DS)) with each candidate AP of the plurality of candidate APs to pre-authenticate the STA, and may output an FT action response frame including pre-authentication information for each candidate AP of the plurality of candidate APs. Other aspects, embodiments, and features are also claimed and described.

### TECHNICAL FIELD

The technology discussed below relates generally to wireless communication systems, and more particularly, to handovers or transitions between access points.

### BACKGROUND

IEEE Specifications for Wi-Fi (e.g., IEEE document 802.11-2020) include an amendment titled IEEE 802.11r, or Fast Basic Service Set (BSS) Transition (FT). This FT amendment provides procedures and protocols for a station (STA) to move from its currently-associated access point (AP) to a target AP with essentially seamless connectivity during the transition. For example, FT can provide for encryption keys to be stored on all APs in a network, providing flexibility to pre-authenticate with a new, target AP without pausing an ongoing data transfer through the connected AP.

As the demand for mobile broadband access continues to increase, research and development continue to advance wireless communication technologies not only to meet the growing demand for mobile broadband access, but to advance and enhance the user experience with mobile communications.

### SUMMARY

The following presents a summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

Fast BSS Transition (FT) over the Distribution System (FToDS) is a set of processes and procedures for a wireless station (STA) operating under 802.11 Wi-Fi to obtain essentially seamless connectivity during a transition from its currently associated access point (AP) to a new, target AP, by performing pre-authentication of the target AP. Current specifications for FToDS only provide for such pre-authentication for a single target AP. Thus, if a transition to a given target AP fails (either pre-authentication fails or reassociation fails), the STA is forced to re-start the FToDS procedure with security information for a different target AP. According to various aspects of the present disclosure, an FToDS procedure is modified to provide for FToDS pre-authentication for a plurality of candidate APs for a later transition. That is, a new information element (IE), referred to herein as a concurrent AP pre-authentication IE, is introduced into FT Action Frames. The concurrent AP pre-authentication IE includes a list of target APs and their authentication information such that multiple candidate APs may be pre-authenticated in one FT Action Frame exchange. Accordingly, if a transition to a given target AP fails (cither pre-authentication fails or reassociation fails), a STA need not start the FToDS procedure over, and may reassociate with any selected target AP from the list of candidate APs that have been pre-authenticated.

In some aspects, a method, apparatus, and non-transitory computer-readable medium for wireless communication at a station (STA) is disclosed. The STA outputs a request frame comprising a list of a plurality of candidate access points (APs). The STA further obtains in response to the request frame a response frame comprising pre-authentication information for each candidate AP of the plurality of candidate APs. The STA further transitions a connection from a currently associated AP to a first AP of the plurality of candidate APs based on the pre-authentication information.

In further aspects, a method, apparatus, and non-transitory computer-readable medium for wireless communication at an access point (AP) is disclosed. The AP obtains a request frame from a station (STA), the request frame comprising a list of a plurality of candidate APs. The AP communicates with each candidate AP of the plurality of candidate APs to pre-authenticate the STA. The AP outputs in response to the request frame a response frame comprising pre-authentication information for each candidate AP of the plurality of candidate APs.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a fast transition over the distribution system (FToDS) procedure according to some aspects of this disclosure.

FIG. 2 is a call flow diagram illustrating signaling in an FToDS procedure according to some aspects of this disclosure.

FIG. 3 is a schematic illustration of an FT Action Request Frame and an FT Action Response Frame according to some aspects of this disclosure.

FIG. 4 is a schematic illustration of a concurrent AP pre-authentication information element (IE) according to some aspects of this disclosure.

FIG. 5 is a block diagram conceptually illustrating an example of a hardware implementation for a station (STA) according to some aspects of this disclosure.

FIG. 6 is a block diagram conceptually illustrating an example of a hardware implementation for an access point (AP) according to some aspects of this disclosure.

FIG. 7 is a call flow diagram illustrating signaling in an FToDS procedure for pre-authenticating a plurality of candidate APs according to some aspects of this disclosure.

FIG. 8 is a call flow diagram illustrating signaling in another FToDS procedure for pre-authenticating a plurality of candidate APs according to some aspects of this disclosure.

FIG. 9 is a flow chart illustrating an example of a process for a currently-associated AP to pre-authenticate a plurality of candidate APs using FToDS according to some aspects of this disclosure.

FIG. 10 is a flow chart illustrating an example of a process for a STA to pre-authenticate a plurality of candidate APs using FToDS according to some aspects of this disclosure.

### DETAILED DESCRIPTION

IEEE Specifications for Wi-Fi (i.e., IEEE document 802.11-2020) include an amendment titled IEEE 802.11r, or Fast BSS Transition (FT). This FT amendment provides procedures and protocols for a STA to move from its currently-associated AP to a target AP with essentially seamless connectivity during the transition. That is, FT provides for encryption keys to be stored on all APs in a network, and can provide flexibility to pre-authenticate with a new, target AP without pausing an ongoing data transfer through the connected AP.

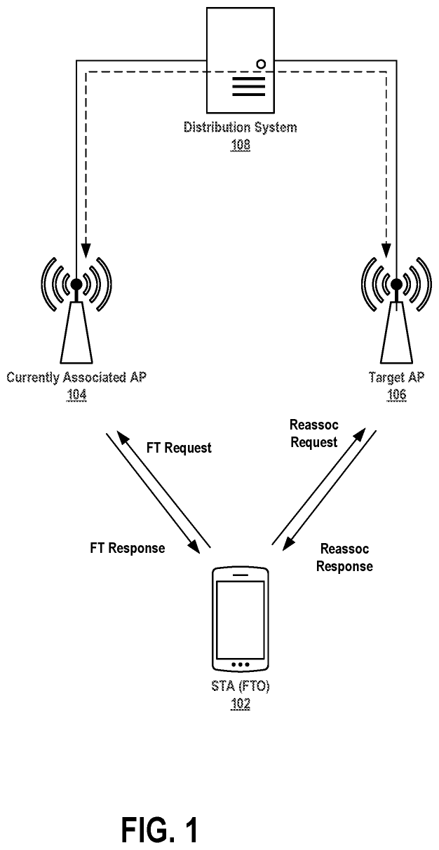

There are two versions of FT: an Over-the-Air version (FToAir) and an Over-the-Distribution System version (FToDS). With FToAir, a wireless station (STA) communicates directly with its target access point (AP) using IEEE 802.11 authentication. However, with FToDS, the STA communicates with the target AP via its currently associated AP. FIG. 1 is a schematic illustration of a STA (also referred to as an FT originator, FTO) 102 undergoing a FToDS procedure from a currently associated AP 104 to a target AP 106. As seen in FIG. 1, the STA 102 communicates with its current AP 104 using FT action frames (FT Request and FT Response), and the currently associated AP 104 communicates the information to the target AP 106 via a distribution system or controller 108. Once the target AP 106 has been pre-authenticated, the STA 102 may then transition to the target AP 106 using a reassociation request and reassociation response message, as described further below. A given AP can advertise its capability to employ this FToDS procedure using a mobility domain element (MDE).

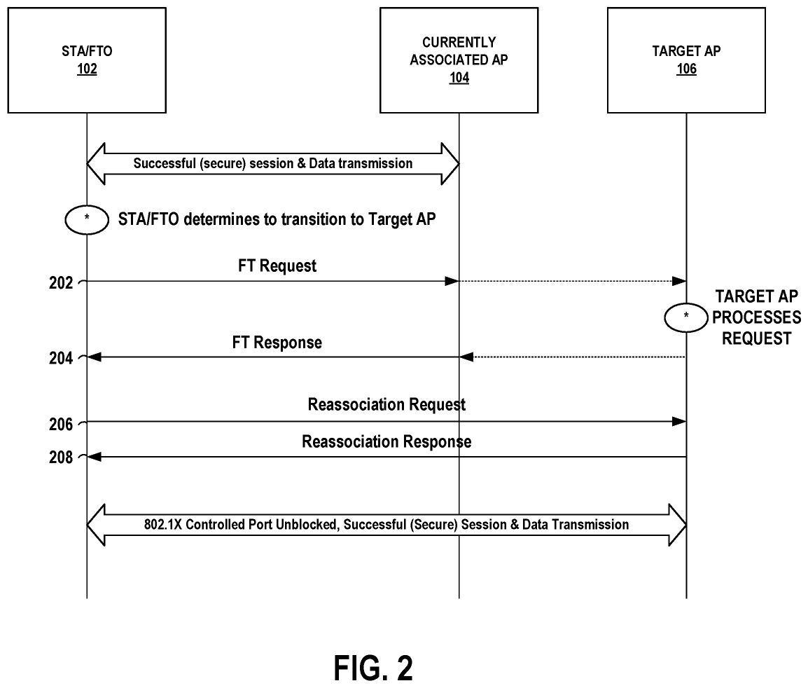

FIG. 2 is a call flow diagram illustrating an FToDS procedure according to one example. An FT authentication sequence includes four messages: an FT request 202, an FT response 204, a reassociation request 206, and a reassociation response 208. The first two messages in the sequence allow the STA 102 and the target AP 106 to provide association instance identifiers, SNonce and ANonce, respectively. SNonce and ANonce may be chosen randomly or pseudorandomly and are used to generate a fresh pairwise transient key (PTK). The first two messages also enable the target AP 106 to provision the pairwise master key (PMK)-R1 keyholder ID (R1KH-ID) and the STA 102 and target AP 106 to compute the PTK. The third message (reassociation request 206) and fourth message (reassociation response 208) demonstrate the liveness of the peer, authenticate the elements, and enable an authenticated resource request.

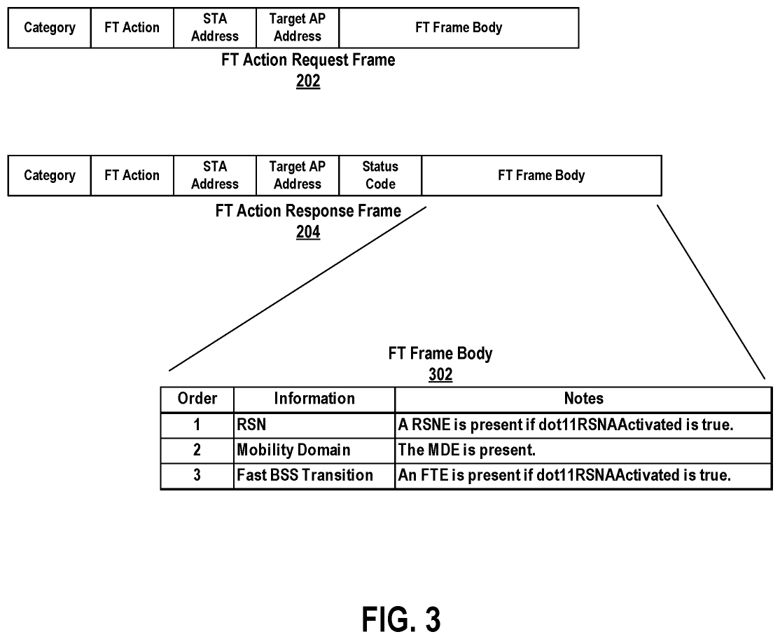

The call flow diagram of FIG. 2 includes a STA 102 in communication with a currently associated AP 104 and a target AP 106, and begins assuming that a successful (secure) session and data transmission have been established between the STA 102 and the currently associated AP 104. From time to time, the STA 102 may determine to transition from its currently associated AP 104 to a target AP 106. To initiate this process, the STA 102 may transmit a first message (e.g., an FT action request frame 202) to its currently associated AP 104. The content of this FT action request frame 202 is illustrated in FIG. 3. The FT action request frame 202 is used as a transport mechanism for data that are destined for the target AP 106. FT action request frame 202 may include a header and an FT frame body 302 (note that the FT frame body also appears in the FT action response frame 204, described below). The header may include information such as a category field, an FT Action field, a STA address field for identifying the FTO 102, and a Target AP address field for identifying the target AP 106. The category and FT Action fields are defined in IEEE specifications for 802.11, and are known to those of ordinary skill in the art. The STA Address field may be set to the FTO's Media Access Control (MAC) address. The Target AP Address field may be set to the basic service set identifier (BSSID) value of the target AP 106. The FT frame body 302 is illustrated at the bottom of FIG. 3, and has a variable bit length and set of contents. In the illustrated example, the FT frame body 302 includes a robust security network element(RSNE) that includes a pairwise master key (PMK) R0 name (RSNE[PMKR0Name]), a mobility domain element (MDE), and a fast BSS transition element (FTE) that can include, among other things, a supplicant nonce (SNonce) and R0 key holder (FTE[SNonce, R0KH-ID]). The usage of these information elements is defined in IEEE specifications for 802.11, and is known to those of ordinary skill in the art so they are not described in detail herein.

The currently associated AP 104 may communicate with the target AP 106 via one or more controllers or a distribution system (DS) 108. For example, the currently associated AP 104 may encapsulate the information elements included in the FT action request frame 202 and send the information to the target AP 106 via the DS 108. The target AP 106 may accordingly communicate preauthentication information to the currently associated AP 104 via the DS 108.

In response to the FT action request frame 202, the currently associated AP 104 may transmit a second message (e.g., an FT action response frame 204) to the STA 102. This FT action response frame 204 is also illustrated in FIG. 3, and is used as a transport mechanism for data that are sourced from the target AP 106. FT response frame 204 may include a header and an FT frame body 302. The header may include information in a category field, an FT action field, a STA address field set to the FTO 102's MAC address, a Target AP address field set to the BSSID value of the target AP 106, and a status code. The status code field indicates whether preauthentication is successful or not with the target AP.

If pre-authentication is successful between the STA 102 and the target AP 106, the STA 102 may then transmit a third message (e.g., a reassociation request 206) to the target AP 106, and may receive a fourth message (e.g., a reassociation response 208) from the target AP 106. The reassociation request 206 may include an RSNE that includes pairwise master key (PMK) R1 name (RSNE[PMKRIName]), an MDE, an FTE that includes a message integrity code (MIC), ANonce, SNonce, R1KH-ID, and R0KH-ID, and a resource information container (RIC-Request). The reassociation response 208 may include RSNE[PMKR1Name], an MDE, an FTE that includes MIC, ANonce, SNonce, R1KH-ID, ROKH-ID, and a group temporal key (GTK[N]). The reassociation response 208 may further include an integrity group temporal key (IGTK[M]) and a resource information container (RIC-Response). The usage of these information elements is defined in IEEE specifications for 802.11, and is known to those of ordinary skill in the art so they are not described in detail herein. When reassociation is complete, the STA 102 may enter into a secure session and data transmission with the target AP 106. That is, the STA 102 may obtain at least one packet from the target AP 106 and may decode the at least one packet based on the PTK. Further, the STA 102 may encode at least one other packet based on the PTK and output the other encoded packet for transmission to the target AP 106.

It may be observed from FIG. 3 that existing FToDS protocols allow for pre-authentication with only one target AP at a time. That is, the first message (FT Request 202) only includes a single target AP address. However, there may be multiple candidate APs to which the STA 102 can roam, or APs to which the STA 102 can transition. If pre-authentication with a given target AP fails, the STA 102 currently re-initiates FT pre-authentication with another candidate AP. Hence, another set of FT action frames 202, 204 may be exchanged with the currently associated AP 104 after a pre-authentication failure. This can result in additional overhead signaling, as well as a potential delay in a handover process.

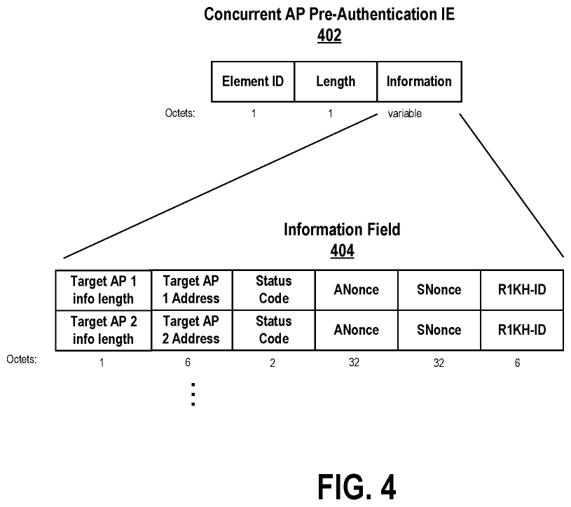

According to various aspects of the present disclosure, APs and STAs may be configured to communicate using FT action frames that include an additional information element (IE) as part of the FT frame body 302. FIG. 4 illustrates an example of such an IE, which may be referred to as a concurrent AP pre-authentication IE 402. Thus, according to techniques disclosed herein, the IE 402 illustrated in FIG. 4 may appear in the FT frame body 302. The concurrent AP pre-authentication IE 402 includes an Element ID field, a Length field, and an Information field. The Element ID field indicates the information element type. The Length field indicates the length of the concurrent AP pre-authentication IE 402.

Rather than only including the BSSID of a single target AP, this new IE provides for an FT Action Request Frame to include a list of target APs, with which the STA seeks pre-authentication. With this information, the currently associated AP can perform pre-authentication over-the-DS with all listed target APs.

Accordingly, if FT pre-authentication and/or reassociation with a first target AP fails, the STA 102 may reassociate with any other pre-authenticated target AP without undertaking another FT Request/FT Response message exchange with its currently associated AP. That is, signaling overhead may be reduced relative to a conventional system where FToDS uses separate FT Request/FT Response messages for each candidate target AP. Moreover, a handover procedure can be expedited, and latency reduced, in a case of an FT preauthentication failure or reassociation failure, as a STA 102 need not necessarily re-start an FT pre-authentication procedure for each candidate target AP. That is, rather than re-starting an FT pre-authentication procedure each time an FT pre-authentication or reassociation fails, a STA 102 may immediately initiate reassociation signaling with any of a plurality of APs for which pre-authentication has been performed.

As described above, FIG. 4 is a diagram illustrating a concurrent AP pre-authentication IE 402 according to one example. The IE 402 may be carried in the FT frame body 302. That is, referring to FIG. 3, FT frame body 302 is illustrated including three information elements, ordered numbers 1 through 3. According to one example, the concurrent AP pre-authentication IE 402 may be item ordered number 4, appearing in the FT frame body 302 after any Fast BSS Transition IE.

The concurrent AP pre-authentication IE 402 includes an Element ID field, a Length field, and an Information field 404. In the illustration of FIG. 4, each row of information field 404 corresponds to a target AP that the STA wishes to authenticate. For each target AP that the STA wishes to authenticate, the information field 404 includes a Target AP information length field, a Target AP Address field, a Status Code field, an ANonce field, an SNonce field, and an R1KH-ID. The Target AP information length field indicates each particular target AP's information contents length. The status code, ANonce, and R1KH-ID fields are applicable only in the FT response frame and may be omitted or may take any value in the FT request frame. The Status code field indicates whether preauthentication is successful or not with the candidate AP. The STA may use the ANonce and the R1KH-ID for generating PMK-R1/PTK keys, and the target AP may use the SNonce for deriving the same.

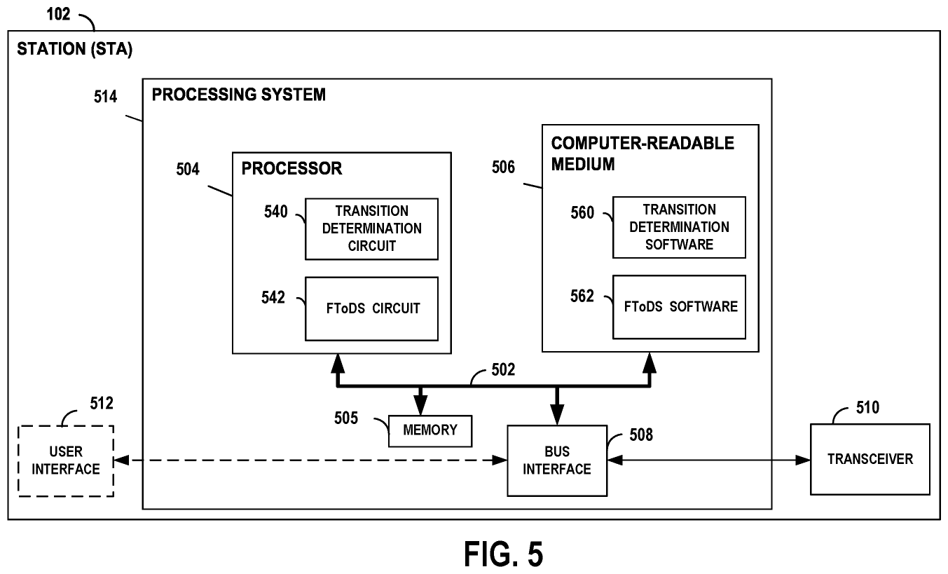

FIG. 5 is a block diagram illustrating an example of a hardware implementation for a STA 102 employing a processing system 514. For example, the STA 102 may be a STA as illustrated in either one or both of FIGS. 1 and/or 2.

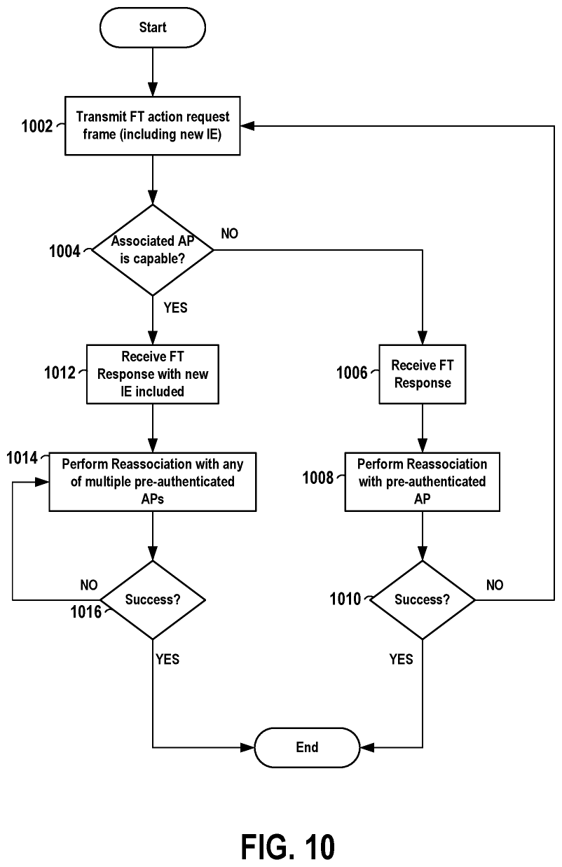

The STA 102 may include a processing system 514 having one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the STA 102 may be configured to perform any one or more of the functions described herein. For example, the processor 504, as utilized in a STA 102, may be configured (e.g., in coordination with the memory 505) to implement any one or more of the processes and procedures described below and illustrated in FIG. 10.

The processing system 514 may be implemented with a bus architecture, represented generally by the bus 502. The bus 502 may include any number of interconnecting buses and bridges depending on the specific application of the processing system 514 and the overall design constraints. The bus 502 communicatively couples together various circuits including one or more processors (represented generally by the processor 504), a memory 505, and computer-readable media (represented generally by the computer-readable medium 506). The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a communication interface or means for communicating with various other apparatus over a transmission medium. Depending upon the nature of the apparatus, a user interface 512 (e.g., keypad, display, speaker, microphone, joystick) may also be provided. Of course, such a user interface 512 is optional, and some examples, such as a base station, may omit it.

In some aspects of the disclosure, the processor 504 may include transition determination circuitry 540 configured (e.g., in coordination with the memory 505) for various functions, including, e.g., monitoring candidate APs, monitoring an associated AP, and determining to transition from the associated AP to a target AP. The processor 504 may further include FToDS circuitry 542 configured (e.g., in coordination with the memory 505) for various functions, including, e.g., outputting an FT request frame, obtaining an FT response frame, transitioning a connection from a currently associated AP (e.g., utilizing a reassociation procedure), generating a PMK-R1 and PTK for candidate APs, and storing the PMK-1 and the PTK for each candidate AP in the memory 505. For example, the FToDS circuitry 542 may be configured to implement one or more of the functions described below in relation to FIG. 10.

The processor 504 is responsible for managing the bus 502 and general processing, including the execution of software stored on the computer-readable medium 506. The software, when executed by the processor 504, causes the processing system 514 to perform the various functions described below for any particular apparatus. The processor 504 may also use the computer-readable medium 506 and the memory 505 for storing data that the processor 504 manipulates when executing software.

One or more processors 504 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 506. The computer-readable medium 506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 506 may reside in the processing system 514, external to the processing system 514, or distributed across multiple entities including the processing system 514. The computer-readable medium 506 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 506 may store computer-executable code that includes transition determination software 560 that configures a STA 102 for various functions, including, e.g., monitoring candidate APs, monitoring an associated AP, and determining to transition from the associated AP to a target AP. The computer-readable storage medium 506 may further store computer-executable code that includes FToDS software 562 that configures a STA 102 for various functions, including, e.g., outputting an FT request frame, obtaining an FT response frame, transitioning a connection from a currently associated AP (e.g., utilizing a reassociation procedure), and generating a PMK-R1 and PTK for candidate APs, and storing the PMK-1 and the PTK for each candidate AP in the memory 505. For example, the FToDS instructions 562 may be configured to cause a STA 102 to implement one or more of the functions described below in relation to FIG. 10.

In one configuration, an apparatus 102 for wireless communication includes means for outputting a FT request frame including a list of a plurality of candidate APs; means for obtaining an FT response frame including pre-authentication information for each candidate AP; means for transitioning a connection from a currently associated AP; means for generating a PMK-R1 and a PTK; means for storing the pMK-R1 and the PTK for each candidate AP; means for obtaining at least one packet from an AP and decoding the at least one packet based on a PTK; and means for encoding at least one other packet based on the PTK. In one aspect, the aforementioned means may be the processor(s) 504 shown in FIG. 5 configured to perform the functions recited by the aforementioned means. In another aspect, the aforementioned means may be a circuit or any apparatus configured to perform the functions recited by the aforementioned means.

Of course, in the above examples, the circuitry included in the processor 504 is merely provided as an example, and other means for carrying out the described functions may be included within various aspects of the present disclosure, including but not limited to the instructions stored in the computer-readable storage medium 506, or any other suitable apparatus or means described in any one of the FIGS. 1, 2, 7, and/or 8, and utilizing, for example, the processes and/or algorithms described herein in relation to FIG. 10.

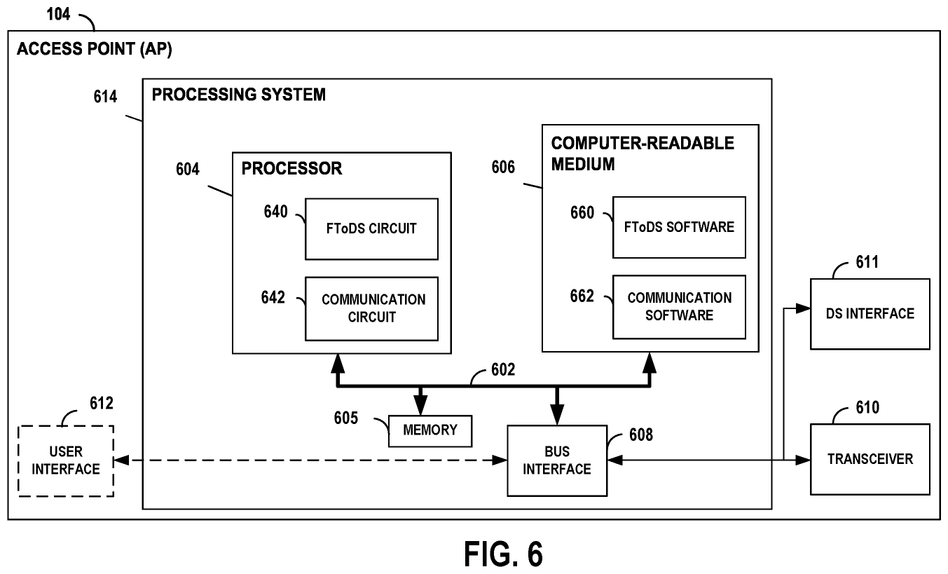

FIG. 6 is a conceptual diagram illustrating an example of a hardware implementation for an exemplary AP 104 employing a processing system 614. In accordance with various aspects of the disclosure, a processing system 614 may include an element, or any portion of an element, or any combination of elements having one or more processors 604. For example, the AP 104 may be an AP as illustrated in either one or both of FIGS. 1 and/or 2.

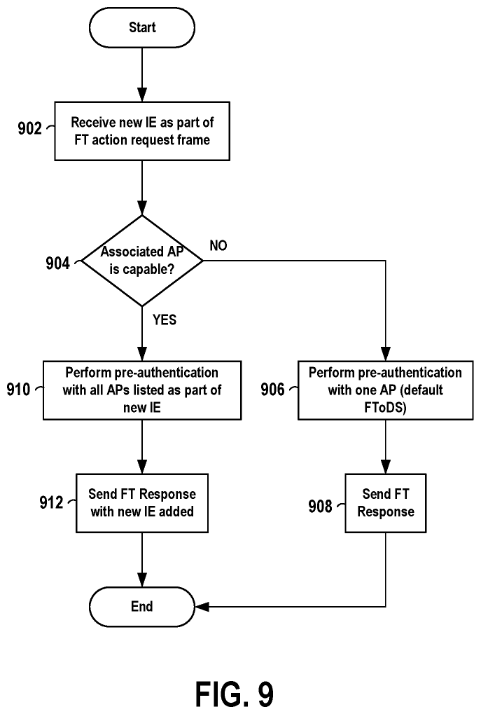

The processing system 614 may be substantially the same as the processing system 514 illustrated in FIG. 5, including a bus interface 608, a bus 602, memory 605, a processor 604, and a computer-readable medium 606. Furthermore, the AP 104 may include a user interface 612 and a transceiver 610 substantially similar to those described above in FIG. 5. The AP 104 may further include a DS interface 611 for communicating with one or more target APs over a distribution system (DS). That is, the processor 604, as utilized in an AP 104, may be configured (e.g., in coordination with the memory 605) to implement any one or more of the processes described below and illustrated in FIG. 9.

In some aspects of the disclosure, the processor 604 may include FToDS circuitry 640 configured (e.g., in coordination with the memory 605) for various functions, including, for example, obtaining a FT request frame from a STA, communicating with a plurality of candidate APs to pre-authenticate the STA, and outputting an FT response frame including pre-authentication information for a plurality of candidate APs. For example, the FToDS circuitry 640 may be configured to implement one or more of the functions described below in relation to FIG. 9. The processor 604 may further include communication circuitry 642 configured (e.g., in coordination with the memory 605) for various functions, including, e.g., establishing, maintaining, and using a communication interface between a STA and the AP 104.

And further, the computer-readable storage medium 606 may store computer-executable code that includes FToDS software 660 that configures an AP 104 for various functions, including, e.g., obtaining an FT request frame from a STA, communicating with a plurality of candidate APs to pre-authenticate the STA, and outputting an FT response frame including pre-authentication information for a plurality of candidate APs. For example, the FToDS software 660 may be configured to cause an AP 104 to implement one or more of the functions described below in relation to FIG. 9. The computer-readable storage medium 606 may further store computer-executable code that includes communication software 662 that configures an AP 104 for various functions, including, e.g., establishing, maintaining, and using a communication interface between a STA and the AP 104.

In one configuration, an apparatus 104 for wireless communication includes means for obtaining a FT request frame from a STA, means for communicating with a plurality of candidate APs to pre-authenticate a STA (e.g., over the DS), and means for outputting, for transmission, an FT response frame including pre-authentication information for a plurality of candidate APs. In one aspect, the aforementioned means may be the processor 604 and/or the transceiver 610 shown in 6 configured to perform the functions recited by the aforementioned means. In another aspect, the aforementioned means may be a circuit or any apparatus configured to perform the functions recited by the aforementioned means.

Of course, in the above examples, the circuitry included in the processor 604 is merely provided as an example, and other means for carrying out the described functions may be included within various aspects of the present disclosure, including but not limited to the instructions stored in the computer-readable storage medium 606, or any other suitable apparatus or means described in any one of the FIGS. 1, 2, 7, and/or 8, and utilizing, for example, the processes and/or algorithms described herein in relation to FIG. 9.

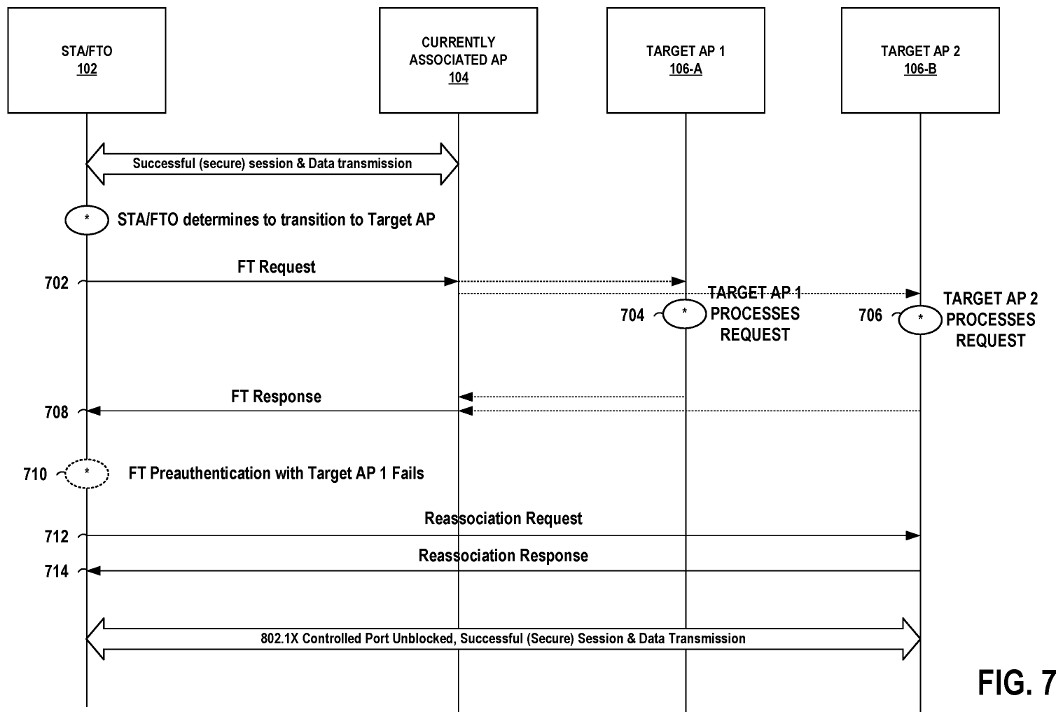

FIG. 7 is a call flow diagram illustrating concurrent AP pre-authentication using FToDS according to an aspect of this disclosure. In FIG. 7, STA/FTO 102 is in communication with currently associated AP 104, and seeks pre-authentication with Target AP 1 106-A and with Target AP 2 106-B. The STA 102 and the APs 104, 106 may be examples of STA 102 illustrated in FIG. 5 and AP 104 illustrated in FIG. 6, respectively.

The call flow diagram of FIG. 7 begins assuming that a successful (secure) session and data transmission have been established between the STA 102 and the currently associated AP 104. From time to time, the STA 102 may determine to transition from its currently associated AP to one of a plurality of target APs 106-A and 106-B. To initiate this process, the STA 102 may transmit a first message (e.g., an FT action request frame 702) that includes the concurrent AP pre-authentication IE 402 described above and illustrated in FIG. 4. That is, the FT action request frame 702 may include a list of a plurality of candidate APs and an SNonce for each respective candidate AP.

Based on the FT action request message 702, the currently associated AP 104 may contact each listed candidate AP over the DS (e.g., DS 108 of FIG. 1), including the information provided for that AP by the STA 102. Thus, at 704, target AP 1 106-A may process the request, and at 706, target AP 2 106-B may process the request. Both target AP 1 106-A and target AP 2 106-B may respond to the currently associated AP 104 with FT preauthentication information, over the DS.

Based on the responses the currently associated AP 104 receives over the DS, the currently associated AP 104 sends a second message (e.g., an FT action response frame 708) to the STA 102. According to an aspect of this disclosure, the FT action response frame 708 includes the concurrent AP pre-authentication IE 402 described above and illustrated in FIG. 4. That is, the FT action response frame 708 may include a list of the plurality of candidate APs, and an ANonce, a SNonce, and an R1KH-ID for each respective candidate AP. The FT action response frame 708 may further include a status code field for each respective candidate AP, to indicate if preauthentication is successful or not with the candidate AP.

In some cases, an FT pre-authentication with a particular target AP may fail. For example, at 710, the STA 102 determines that the FT pre-authentication with target AP 1 106-A fails. Accordingly, the STA 102 may skip target AP 1 106-A and may transmit a reassociation request 712 to target AP 2 106-B. The reassociation request 712 and a reassociation response 714 may be the same as those described above and illustrated in FIG. 2. Once reassociation is complete, the STA 102 may enter into a secure session and data transmission with target AP 2 106-B. Thus, according to aspects of the present disclosure, the STA 102 need not start the FToDS process over when an FT pre-authentication fails, and need not transmit another FT action request frame indicating a different target AP. Rather, the STA 102 may select any suitable target AP from the list of target APs for which FT pre-authentication is successful.

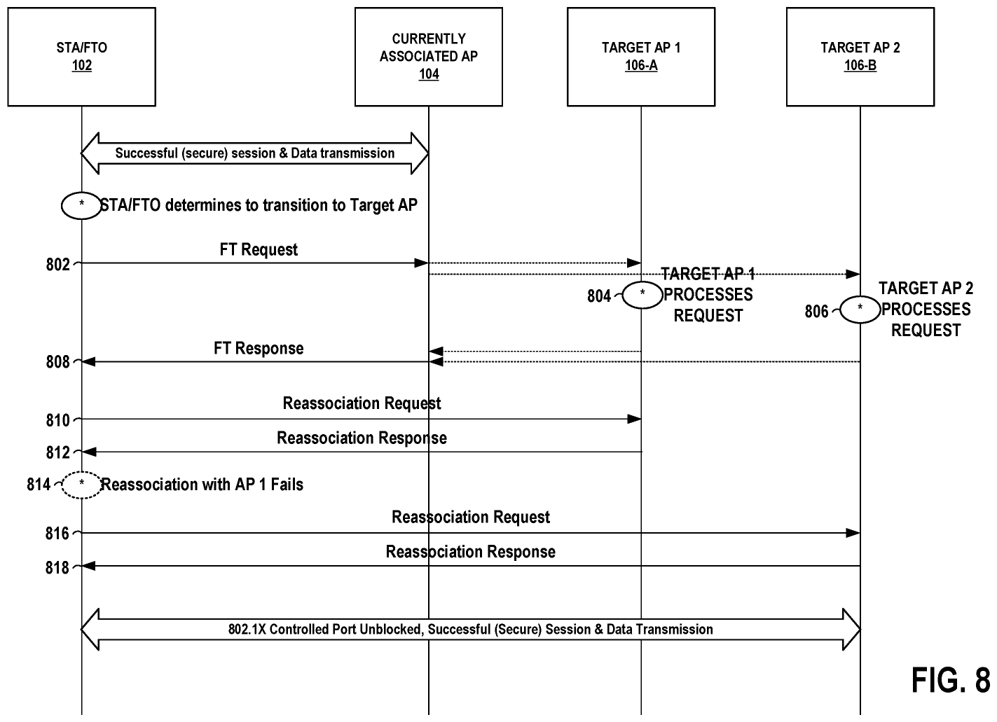

FIG. 8 is a call flow diagram illustrating concurrent AP pre-authentication using FToDS according to a further aspect of this disclosure. In FIG. 8, STA/FTO 102 is in communication with a currently associated AP 104, and seeks pre-authentication with Target AP 1 106-A and with Target AP 2 106-B. The STA 102 and the APs 104, 106 may be examples of STA 102 illustrated in FIG. 5 and AP 104 illustrated in FIG. 6, respectively.

The call flow diagram of FIG. 8 begins assuming that a successful (secure) session and data transmission have been established between the STA 102 and the currently associated AP 104. From time to time, the STA 102 may determine to transition from its currently associated AP to one of a plurality of target APs 106-A and 106-B. To initiate the process, the STA 102 may transmit a first message (e.g., an FT action request frame 802) that includes the concurrent AP pre-authentication IE 402 described above and illustrated in FIG. 4. That is, the FT action request frame 802 may include a list of a plurality of candidate APs and an SNonce for each respective candidate AP.

Based on the FT action request message 802, the currently associated AP 104 may contact each listed candidate AP over the DS, including the information provided for that AP by the STA 102. Thus, at 804, target AP 1 106-A may process the request, and at 806, target AP 2 106-B may process the request. Both target AP 1 106-A and target AP 2 106-B may respond to the currently associated AP 104 with FT preauthentication information, over the DS.

Based on the responses the currently associated AP 104 receives over the DS, the currently associated AP 104 sends a second message (e.g., an FT action response frame 808) to the STA 102. According to an aspect of this disclosure, the FT action response frame 808 includes the concurrent AP pre-authentication IE 402 described above and illustrated in FIG. 4. That is, the FT action response frame 808 may include a list of the plurality of candidate APs, and an ANonce, a SNonce, and an R1KH-ID for each respective candidate AP. The FT action response frame 808 may further include a status code field for each respective candidate AP, to indicate if preauthentication is successful or not with the candidate AP.

Assuming pre-authentication is successful, as indicated by the FT action response frame 808, the STA 102 may transmit a reassociation request 810 to a selected target AP. The STA 102 may transmit the reassociation request 810 to any suitable target AP from the list of target APs for which FT pre-authentication was successful. For example, the STA 102 may transmit a reassociation request 810 to target AP 1 106-A, and may receive in response a reassociation response 812.

In some cases, a reassociation with a particular target AP may fail despite a successful FT pre-authentication with that target AP. For example, at 814, the STA 102 determines that the reassociation with target AP 1 106-A fails. Accordingly, the STA 102 may attempt a reassociation with any other suitable target AP in the list of candidate APs for which pre-authentication is successful. For example, the STA 102 may transmit a second reassociation request 816 to target AP 2 106-B, and may receive in response a second reassociation response 818. Once reassociation is complete, the STA 102 may enter into a secure session and data transmission with target AP 2 106-B. Thus, according to aspects of the present disclosure, the STA 102 need not start the FToDS process over when a reassociation fails, and need not transmit another FT action request frame indicating a different target AP. Rather, the STA 102 may select any suitable target AP from the list of target APs for which FT pre-authentication is successful.

FIG. 9 is a flow chart illustrating an exemplary process for a currently associated AP in accordance with some aspects of the present disclosure. As described below, a particular implementation may omit some or all illustrated features, and may not require some illustrated features to implement all embodiments. In some examples, the AP 104 illustrated in FIG. 6 may be configured to carry out the process of FIG. 9. In some examples, any suitable apparatus or means for carrying out the functions or algorithm described below may carry out the process of FIG. 9.

At block 902, the associated AP 104 may receive an FT action request frame including a concurrent AP pre-authentication IE 402 as described above and illustrated in FIG. 4. In some cases, an associated AP may lack the capability to perform concurrent AP pre-authentication as described in the present disclosure. In such case, the associated AP may not expect or understand the concurrent AP pre-authentication IE 402. However, according to an aspect of this disclosure, the concurrent AP pre-authentication IE 402 is included in the FT frame body 302 (see FIG. 3). Thus, a legacy AP that lacks the capability to perform concurrent AP pre-authentication (NO branch of 904) may proceed to block 906, wherein the legacy AP may perform pre-authentication with one AP (the target AP identified in the FT action request frame 202) according to legacy procedures (e.g., sec FIG. 2). That is, the legacy AP may transmit the information from the FT action request frame 202 to the target AP over the DS, and may receive a response from the target AP over the DS. At block 908, the legacy AP may send an FT action response frame 204. In this example, the FT action response frame 204 may lack the concurrent AP pre-authentication IE 402.

However, an AP 104 that has the capability to perform concurrent AP pre-authentication (YES branch of 904) may proceed to block 910, wherein the associated AP 104 may perform pre-authentication over the DS with all APs listed in the FT action request frame 202, including those identified in the concurrent AP pre-authentication IE 402 in the FT frame body 302. Thus, in response to the FT action request frame, at block 912 the associated AP 104 may transmit an FT action response frame 204 including the concurrent AP pre-authentication IE 402. In this manner, the associated AP 104 may pre-authenticate a plurality of candidate target APs. Accordingly, the associated AP 104 may reduce transition latency in the case that FT pre-authentication with a target AP, or reassociation with a target AP, fails.

FIG. 10 is a flow chart illustrating an exemplary process for a STA in accordance with some aspects of the present disclosure. As described below, a particular implementation may omit some or all illustrated features, and may not require some illustrated features to implement all embodiments. In some examples, the STA 102 illustrated in FIG. 5 may be configured to carry out the process of FIG. 10. In some examples, any suitable apparatus or means for carrying out the functions or algorithm described below may carry out the process of FIG. 10.

At block 1002, the STA 102 may transmit an FT action request frame including a concurrent AP pre-authentication IE 402 as described above and illustrated in FIG. 4. In some cases, the associated AP may lack the capability to perform concurrent AP pre-authentication as described in the present disclosure. In such case, the associated AP may not expect or understand the concurrent AP pre-authentication IE 402. Thus, if the associated AP is not capable of performing concurrent AP pre-authentication (NO branch of 1004), the process may proceed to block 1006, where the STA 102 may receive an FT action response frame 204. In this example, the FT action response frame 204 may lack the concurrent AP pre-authentication IE 402. That is, the FT action response frame 204 may appear as illustrated in FIG. 2, and may include information relating to only a single target AP.

At block 1008, the STA 102 may attempt to perform reassociation with the pre-authenticated target AP. However, in some cases, the FT action response frame 204 may indicate that the pre-authentication procedure failed; and in some cases, a reassociation with a pre-authenticated target AP may fail. In such cases (NO branch of 1010), the process may return to block 1002. That is, if the legacy FToDS procedure that lacks the concurrent AP pre-authentication IE 402 fails, the STA 102 has no recourse but to start the FToDS procedure over.

However, if the associated AP has the capability to perform concurrent AP pre-authentication (YES branch of 1004), the process may proceed to block 1012, and the STA 102 may receive an FT action response frame 204 including the concurrent AP pre-authentication IE 402 with pre-authentication information for a set of one or more candidate target APs.

With the pre-authentication information corresponding to a plurality of target APs, at block 1014, the STA 102 may select from the plurality of pre-authenticated target APs and may perform a reassociation process, as described above, with the selected, pre-authenticated target AP. If the reassociation with the selected target AP is unsuccessful (NO branch of 1016), the process may return to block 1014, where the STA 102 may select a different target AP from the plurality of pre-authenticated target APs and may perform a reassociation process with the selected, pre-authenticated target AP. Thus, the STA 102 can avoid the need to start the FToDS procedure over when a reassociation fails, and may move to the next pre-authenticated target AP in its list for a reassociation attempt.

### Further Examples Having a Variety of Features

The following numbered clauses are illustrative only and may be combined with aspects of other embodiments or teachings described herein, without limitation.

Clause 1: A method of wireless communication at a station (STA), the method comprising: outputting a request frame comprising a list of a plurality of candidate access points (APs); obtaining in response to the request frame a response frame comprising pre-authentication information for each candidate AP of the plurality of candidate APs; and transitioning a connection from a currently associated AP to a first AP of the plurality of candidate APs based on the pre-authentication information.

Clause 2: the method of clause 1, wherein the request frame comprises a concurrent AP pre-authentication information element (IE) comprising: the list of the plurality of candidate APs and a supplicant nonce (SNonce) for each respective candidate AP of the plurality of candidate APs.

Clause 3: the method of either of clauses 1 or 2, wherein the response frame comprises a concurrent AP pre-authentication information element (IE) comprising the list of the plurality of candidate APs, the list of the plurality of candidate APs comprising, for each respective candidate AP of the plurality of candidate APs: an authenticator nonce (ANonce), a supplicant nonce (SNonce), and an R1 key holder identifier (R1KH-ID).

Clause 4: the method of clause 3, wherein the concurrent AP pre-authentication IE further comprises a status field for indicating if preregistration corresponding to each respective candidate AP of the plurality of candidate APs is successful.

Clause 5: the method of clause 3, further comprising: for each candidate AP of the plurality of candidate APs, generating a pairwise master key (PMK)-R1 and a pairwise transient key (PTK) based on the corresponding ANonce and the R1KH-ID; and storing the PMK-R1 and the PTK for each candidate AP in memory.

Clause 6: the method of clause 5, further comprising at least one of: obtaining at least one packet from the first AP and decoding the at least one packet based on the PTK; or encoding at least one other packet based on the PTK and outputting the at least one other encoded packet for transmission.

Clause 7: a method of wireless communication at an access point (AP), the method comprising: obtaining a request frame from a station (STA), the request frame comprising a list of a plurality of candidate APs; communicating with each candidate AP of the plurality of candidate APs to pre-authenticate the STA; and outputting in response to the request frame a response frame comprising pre-authentication information for each candidate AP of the plurality of candidate APs.

Clause 8: the method of clause 7, wherein the request frame comprises a concurrent AP pre-authentication information element (IE) comprising: the list of the plurality of candidate APs and a supplicant nonce (SNonce) for each respective candidate AP of the plurality of candidate APs.

Clause 9: the method of either of clauses 7 or 8, wherein the response frame comprises a concurrent AP pre-authentication information element (IE) comprising the list of the plurality of candidate APs, the list of the plurality of candidate APs comprising, for each respective candidate AP of the plurality of candidate APs: an authenticator nonce (ANonce), a supplicant nonce (SNonce), and a pairwise master key (PMK)-R1 key holder identifier (R1KH-ID) for each respective candidate AP of the plurality of candidate APs.

Clause 10: the method of claim 9, wherein the concurrent AP pre-authentication IE further comprises a status field for indicating if preregistration corresponding to each respective candidate AP of the plurality of candidate APs is successful.

Clause 11: a wireless station (STA) comprising: a transceiver, a memory comprising instructions, and one or more processors configured to execute the instructions to cause the STA to perform a method in accordance with any one of clauses 1-6, wherein the transceiver is configured to: transmit the request frame; receive the response frame; and communicate with the first AP of the plurality of candidate APs.

Clause 12: an access point (AP) comprising: a transceiver, a memory comprising instructions, and one or more processors configured to execute the instructions to cause the AP to perform a method in accordance with any one of clauses 7-10, wherein the transceiver is configured to receive the request frame; and to transmit the response frame.

Clause 13: an apparatus for wireless communications, comprising means for performing a method in accordance with any one of examples 1-10.

Clause 14: a non-transitory computer-readable medium comprising instructions that, when executed by an apparatus, cause the apparatus to perform a method in accordance with any one of examples 1-10.

Clause 15: an apparatus for wireless communications, comprising: a memory comprising instructions; and one or more processors configured to execute the instructions to cause the apparatus to perform a method in accordance with any one of examples 1-10.

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-10 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-10 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method of wireless communication at a station (STA), the method comprising:
outputting, for transmission, a request frame comprising a list of a plurality of candidate access points (APs);
obtaining in response to the request frame a response frame comprising pre-authentication information for each candidate AP of the plurality of candidate APs; and
transitioning a connection from a currently associated AP to a first AP of the plurality of candidate APs based on the pre-authentication information.

2. The method of claim 1, wherein the request frame comprises a concurrent AP pre-authentication information element (IE) comprising: the list of the plurality of candidate APs and a supplicant nonce (SNonce) for each respective candidate AP of the plurality of candidate APs.

3. The method of claim 1, wherein the response frame comprises a concurrent AP pre-authentication information element (IE) comprising the list of the plurality of candidate APs, the list of the plurality of candidate APs comprising, for each respective candidate AP of the plurality of candidate APs:
an authenticator nonce (ANonce),
a supplicant nonce (SNonce), and
an R1 key holder identifier (R1KH-ID).

4. The method of claim 3, wherein the concurrent AP pre-authentication IE further comprises a status field for indicating if preregistration corresponding to each respective candidate AP of the plurality of candidate APs is successful.

5. The method of claim 3, further comprising:
for each candidate AP of the plurality of candidate APs, generating a pairwise master key (PMK)-R1 and a pairwise transient key (PTK) based on the corresponding ANonce and the R1KH-ID; and
storing the PMK-R1 and the PTK for each candidate AP in memory.

6. The method of claim 5, further comprising, at least one of:
obtaining at least one packet from the first AP and decoding the at least one packet based on the PTK; or
encoding at least one other packet based on the PTK and outputting the at least one other encoded packet for transmission.

7. An apparatus for wireless communication, comprising:
a memory to store instructions; and
a processor coupled to the memory and configured to execute the instructions, the instructions comprising code for causing the apparatus to:
output, for transmission, a request frame comprising a list of a plurality of candidate access points (APs);
obtain in response to the request frame a response frame comprising pre-authentication information for each candidate AP of the plurality of candidate APs; and
transition a connection from a currently associated AP to a first AP of the plurality of candidate APs based on the pre-authentication information.

8. The apparatus of claim 7, wherein the request frame comprises a concurrent AP pre-authentication information element (IE) comprising: the list of the plurality of candidate APs and a supplicant nonce (SNonce) for each respective candidate AP of the plurality of candidate APs.

9. The apparatus of claim 7, wherein the response frame comprises a concurrent AP pre-authentication information element (IE) comprising the list of the plurality of candidate APs, the list of the plurality of candidate APs comprising, for each respective candidate AP of the plurality of candidate APs:
an authenticator nonce (ANonce),
a supplicant nonce (SNonce), and
an R1 key holder identifier (R1KH-ID).

10. The apparatus of claim 9, wherein the concurrent AP pre-authentication IE further comprises a status field for indicating if preregistration corresponding to each respective candidate AP of the plurality of candidate APs is successful.

11. The apparatus of claim 9, wherein the processor is further configured to execute instructions comprising code for causing the apparatus to:
for each candidate AP of the plurality of candidate APs, generate a pairwise master key (PMK)-R1 and a pairwise transient key (PTK) based on the corresponding ANonce and the R1KH-ID; and
store the PMK-R1 and the PTK for each candidate AP in memory.

12. The apparatus of claim 11, wherein the processor is further configured to execute instructions comprising code for causing the apparatus to perform at least one of:
obtain at least one packet from the first AP and decoding the at least one packet based on the PTK; or
encode at least one other packet based on the PTK and outputting the at least one other encoded packet for transmission.

13. The apparatus of claim 7, further comprising a transceiver configured to:
transmit the request frame;
receive the response frame; and
transition the connection from the currently associated AP to the first AP, wherein the apparatus is configured as a STA.

14. An apparatus for wireless communication comprising:
a memory to store instructions; and
a processor coupled to the memory and configured to execute the instructions, the instructions comprising code for causing the apparatus to:
obtain a request frame from a station (STA), the request frame comprising a list of a plurality of candidate access points (APs);
communicate with each candidate AP of the plurality of candidate APs to pre-authenticate the STA; and
output, for transmission, in response to the request frame, a response frame comprising pre-authentication information for each candidate AP of the plurality of candidate APs.

15. The apparatus of claim 14, wherein the request frame comprises a concurrent AP pre-authentication information element (IE) comprising: the list of the plurality of candidate APs and a supplicant nonce (SNonce) for each respective candidate AP of the plurality of candidate APs.

16. The apparatus of claim 14, wherein the response frame comprises a concurrent AP pre-authentication information element (IE) comprising the list of the plurality of candidate APs, the list of the plurality of candidate APs comprising, for each respective candidate AP of the plurality of candidate APs:
an authenticator nonce (ANonce),
a supplicant nonce (SNonce), and
a pairwise master key (PMK)-R1 key holder identifier (R1KH-ID) for each respective candidate AP of the plurality of candidate APs.

17. The apparatus of claim 16, wherein the concurrent AP pre-authentication IE further comprises a status field for indicating if preregistration corresponding to each respective candidate AP of the plurality of candidate APs is successful.

18. The apparatus of claim 14, further comprising:
a transceiver configured to:
receive the request frame from the STA; and
transmit the response frame, wherein the apparatus is configured as an AP.
